(19) United States
(12) Patent Application Publication
(10) Pub. No.: US 2022/0298647 A1
(43) Pub. Date: Sep. 22, 2022

(54) METHOD OF FINISHING A METALLIC SURFACE

(71) Applicant: 3M INNOVATIVE PROPERTIES COMPANY, St. Paul, MN (US)

(72) Inventor: Christopher J. Carter, Hinckley (GB)

(21) Appl. No.: 17/616,100

(22) PCT Filed: May 27, 2020
(86) PCT No.: PCT/IB2020/055046

§ 371 Date: Dec. 2, 2021

Related U.S. Application Data
(60) Provisional application No. 62/858,583, filed on Jun. 7, 2019.

(51) Int. Cl. C23F 1/02; C23F 1/20

(52) U.S. Cl. CPC C23F 1/02; C23F 1/20

(57) ABSTRACT

A method of finishing a metallic surface includes the steps of: disposing a mask layer onto an initial metallic surface of a substrate, etching at least a portion of the initial metallic surface with an etchant to provide an etched surface, and separating the etchant from the etched surface. The etched surface is smoother than the initial metallic surface. On a depth basis: the etchant etches said at least a portion of the mask layer and said at least a portion of the initial metallic surface at substantially the same rate; and/or the etchant penetrates said at least a portion of the mask layer and etches said at least a portion of the initial metallic surface at substantially the same rate. A substrate finished by the disclosed method and a kit for practicing the method are also disclosed.

### TECHNICAL FIELD

The present disclosure broadly relates to metal finishing, and in particular to finishing of sintered metal surfaces.

### BACKGROUND

3-D printing processes using metal powders generally result in metal bodies having a rough surface finish. As used herein, the term “3-D printed” refers to an additive manufacturing process (e.g., laser sintering or powder jet printing) in which layers of powder particles (e.g., metal powder particles) are sequentially deposited in a process that ultimately results in a sintered metal body.

In many cases, 3-D printed metal bodies have complex shapes with internal surfaces that make them poor candidates for abrasive surface finishing techniques.

Accordingly, chemical-etching has been considered. However, this technique has limitations such as the tendency of the etchant to etch deeply into surface pores, rather than just etching raised portions of the surface. As a result, good smoothness is difficult to impossible by this method.

### SUMMARY

The present disclosure overcomes the above deficiency of etching methods, and provides a method capable of finishing metal surfaces that have improved smoothness as compared to prior etching methods of surface finishing. The method is especially applicable to 3-D printed metal bodies having complex shapes.

In one aspect, the present disclosure provides a method of finishing a metallic surface, the method comprising steps:
(a) disposing a mask layer onto an initial metallic surface of a substrate, wherein the mask layer has a major surface opposite the initial metallic surface that is smoother than the initial metallic surface;
(b) etching at least a portion of the initial metallic surface with an etchant to provide an etched surface, wherein on a depth basis:
   (i) the etchant etches said at least a portion of the mask layer and said at least a portion of the initial metallic surface at substantially the same rate; and/or
   (ii) the etchant penetrates said at least a portion of the mask layer and etches said at least a portion of the initial metallic surface at substantially the same rate; and
(c) separating the etchant from the etched surface, wherein the etched metallic surface is smoother than the initial metallic surface.

In another aspect, the present disclosure provides a substrate having a metallic surface wherein at least a portion of the metallic surface is finished by a process comprising a method of finishing a metallic surface according to the present disclosure.

In yet another aspect, the present disclosure provides a kit comprising components:

(a) a mask layer precursor composition for use in disposing a mask layer at least a portion of a metallic surface comprising at least one specified metal; and

(b) an etchant adapted for use with the mask layer and the at least one specified metal, wherein at a predetermined specified nominal temperature, and on a depth basis:
(i) the etchant etches said at least a portion of the mask layer and said at least a portion of the initial metallic surface at substantially the same rate; and/or
(ii) the etchant is capable of permeating said at least a portion of the mask layer and etching said at least a portion of the metallic surface at substantially the same rate.

Methods according to the present disclosure are well-suited for finishing surfaces of 3-D printed bodies, and especially 3-D printed bodies having relatively inaccessible surface regions.

As used herein: the term “substantially” means at least 85 percent, preferably at least 90 percent, and more preferably at least 95 percent, or even 100 percent.

Features and advantages of the present disclosure will be further understood upon consideration of the detailed description as well as the appended claims.

### BRIEF DESCRIPTION OF THE DRAWINGS

FIG. 1 is a schematic process flow diagram of an exemplary method of finishing a metallic surface according to the present disclosure.

FIG. 2 is a schematic process flow diagram of another exemplary method of finishing a metallic surface according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

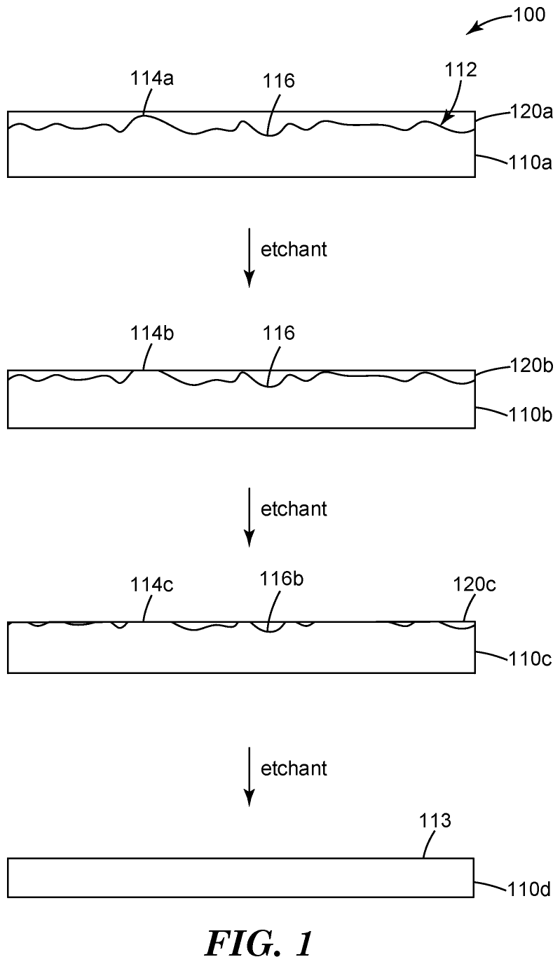

Referring now to FIG. 1, exemplary method 100 according to the present disclosure involves etching of an initial metallic surface 112 of a substrate 110a having peaks 114a and valleys 116. Prior to etching, a mask layer 120a is disposed on initial metallic surface 112. The resulting masked surface is then exposed to etchant that begins to eat away at mask layer 120 and peaks 114a, resulting in a partially etched mask layer 120b and one or more partially flattened peaks 114b on substrate 110b. Further exposure to etchant eats away further at mask layer 120b and peaks 114b, resulting in a further etched metallic surface having further flattened peaks 114c and shallower valley 116b. Finally, after further etching (and typically rinsing) substrate 110d has a smooth etched surface 113. It will be recognized that this is a simplification of the process for illustration of the concept and that in reality the etched surface may still have a degree of roughness, albeit less roughness that the initial metallic surface.

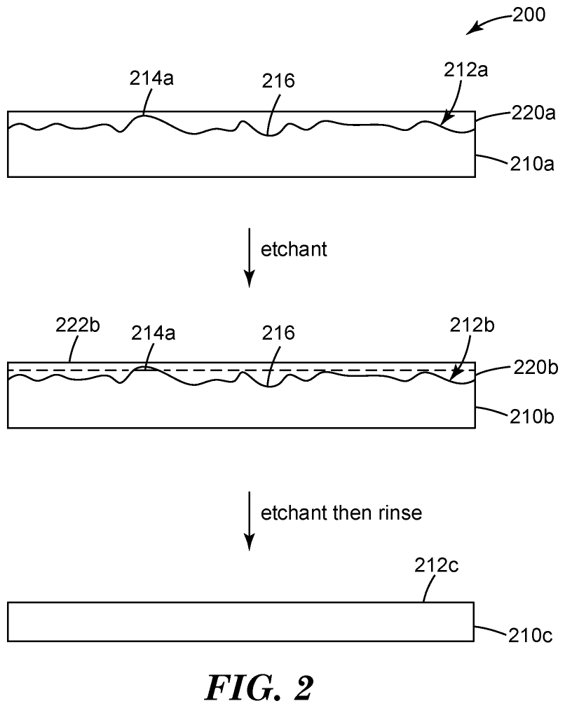

Referring now to FIG. 2, another exemplary method 200 according to the present disclosure involves etching of an initial metallic surface 212a of a substrate 210a having peak 214a and valley 216. Mask layer 220a is disposed on initial metallic surface 212a. Mask layer 220a is then exposed to an etchant that begins to permeate mask layer 220a resulting in permeated mask layer 222b and non-permeated mask layer 220b. Upon reaching peak 214a the etchant begins to etch it, resulting in flattened (etched) peak 214b. Further exposure to the etchant eats away further at mask layer 220b and metallic surface 220b of substrate 201b, and after rinsing away the etching and removing residual permeated mask layer, the ultimate result is a smoothed etched metallic surface 212c on substrate 210c. It will be recognized that this is a simplification of the process for illustration of the concept and that in reality the etched surface may still have a degree of roughness, albeit less roughness that the initial metallic surface.

Any substrate having an etchable metal surface comprising at least a portion of its surface may be used in practice of the present disclosure. Exemplary etchable metals may comprise any etchable metal from group 2 through to group 15 of the Periodic Table of the Elements. Alloys of these metals, optionally with one or more elements (e.g., metals and/or non-metals such as carbon, silicon, or boron) in groups 1 and 15 of the Periodic Table of the Elements may also be used. Examples of suitable metal particles include powders comprising magnesium, aluminum, iron, titanium, niobium, tungsten, chromium, tantalum, cobalt, nickel, vanadium, zirconium, molybdenum, palladium, platinum, copper, silver, gold, cadmium, tin, indium, tantalum, zinc, alloys containing one or more of the foregoing metals and optionally carbon, silicon, and/or boron, and combinations thereof. Preferred etchable metals include iron, nickel, titanium, aluminum, and alloys containing at least one of these metals. Exemplary iron-based alloys include stainless, carbon, and silicon steels. Exemplary nickel-based alloys include Kovar and Invar iron-nickel alloys, and those alloys whose major fraction is nickel such as, for example, Alloy 42 (Ni+Fe), Mu-metal (Ni+Fe), Inconel (Ni+Cr+Fe), and Monel (Ni+Cu).

The substrate may have any shape. For example, it may be planar, curviplanar, or some other 3-dimensional complex shape. The substrate may have inaccessible regions wherein portions of the surface are readily accessible to liquids but not abrasive tools such as, for example, abrasive belts, discs, and/or wheels. Exemplary substrates include medical devices (e.g., artificial joints), architectural and/or ornamental castings, engine components parts, turbine blades, propellers. 3-D printed metal substrates are particularly suitable. In some preferred embodiments, the substrate comprises at least one metallic surface having projections and/or crevices.

Due to the method involved, rapid prototyping methods such as laser powder sintering and powder jet printing (following by sintering) result in sintered metal bodies having a sintered metallic surface comprising sintered metal powder particles and crevices (and/or peaks). Details concerning laser sintering can be found in, for example, U.S. Pat. No. 4,938,816 (Beaman et al.); U.S. Pat. No. 5,155,324 (Deckhard et al.); and U.S. Pat. No. 5,733,497 (McAlea). Details concerning powder jet printing techniques can be found, for example, in U.S. Pat. No. 5,340,656 (Sachs et al.); U.S. Pat. No. 6,403,002 Bl (van der Geest); and U.S. Pat. Appl. Publ. No. 2018/0126515 (Franke et al.).

### Etching

The mask layer etches at substantially the same rate as the metallic surface to which is applied. Accordingly, the selection of materials to include in the mask layer will depend on the metal present and on the etchant. Consequently, many materials may be used.

In one embodiment, the mask layer comprises one or more waxes. Suitable waxes may include, for example: synthetic waxes such as polyether waxes (e.g., polyethylene oxide wax or polypropylene oxide wax, and amide waxes) and a blend of sugar cane wax and stearic acid wax; plant-origin waxes (carnauba wax, candelilla wax, bayberry wax, castor wax, soy wax, tallow tree wax, and ouricury wax); animal-origin waxes (e.g., beeswax and lanolin); mineral waxes(e.g., ceresin waxes, ozocerite, montan, and peat waxes); and petroleum-based waxes (e.g., paraffin waxes and microcrystalline waxes). In some embodiments, suitable waxes have a melting point above about 40° C., above 50° C., or even above 60° C.

Examples of suitable amide waxes may include ethylene-bis-stearamide (EBS) waxes, erucamice waxes, oleamide waxes and stearamide waxes, many of which are commercially available from Duerex AG, Elsteraue, Germany. Combinations of waxes (hybrid waxes) may also be used. One useful amide wax is available as DEUREX STEARAMIDE WAX A28P from Duerex AG. Waxes may be coated, for example, out of organic solvents such as, for example, ketones, ethers, esters, and combinations thereof.

In some embodiments, wax is combined with other components that modify the rate of etching and/or permeation by the etchant. Exemplary other components may include fillers, organic polymers (e.g., acrylics, polyethers, polyvinyl ethers, vinyl acetates and copolymers of vinyl acetate, polyvinyl alcohols, polyurethanes, phenolics, polyesters, and/or polyamides).

During etching, the mask layer may be etched by any suitable method including, for example, dissolution, hydrolysis, oxidation, and combinations thereof. May degrade by any mechanism, including oxidation, and hydrolysis, for example. In some another embodiments, the mask layer is permeable to the etchant. In these embodiments, the mask layer is permeated by the etchant until it contacts the metallic surface, where it begins to etch the metallic surface. In such embodiments, the etching of the metallic surface may result in a volume of etchant and/or etched material and byproducts (e.g., hydrogen) accumulating beneath the mask layer. In such cases, a portion of the mask layer may become detached; however, since the etchant had already contacted the metallic surface, this may not be problematic.

In embodiments involving etching, the mask layer may include a suitable organic and/or inorganic material. In some embodiments, the mask layer may include an impermeable or semipermeable polymer that hydrolyzes in the presence of the etchant and becomes permeable to the etchant and/or etches away, for example. In some embodiments, the mask layer comprises a crosslinked polymer matrix. Any crosslinked organic polymer may be used. Examples of polymers that can form crosslinked polymer matrixes include (meth)acrylic polymers (especially meth)acrylic polymers that incorporate a crosslinking polyfunctional monomer), phenolics, polyurethanes, gelatin, cured alkyd resins, cured urea-formaldehyde resins, cured melamine-formaldehyde resins, cured methylol-urea resins, cyanates, and combinations thereof). As used herein, the term “methacryl” refers to “acryl and/or methacryl”.

In some embodiments, the mask layer comprises a crosslinked polymeric material. Crosslinking may be via hydrogen bonds (e.g., gelatin, polyvinyl alcohol), ionic bonds (e.g., zinc crosslinked acrylic acid (co)polymers), and/or covalent bonds. In cases where permeability of the etchant is important the degree of crosslinking is typically kept low so that some swelling and penetration by the etchant can occur. Crosslinking may occur during polymerizable of a mask layer precursor composition or by crosslinking preexisting polymer chains, for example. The selection and amount of crosslinker will necessarily depend on the polymer to be crosslinked, and will be apparent to those of skill in the art. Crosslinkers may be inorganic (e.g., metal ions), organic (e.g., peroxides, polyamines, polyaldehydes, polyisocyanates, and/or polyaziridines). Exemplary thermal free-radical initiators include benzoyl peroxide and chlorobenzoyl peroxide.

Details concerning methods of making crosslinked (meth)acrylic compositions are well-known and can be found, for example, in U.S. Pat. Nos.

Suitable ethylenically-unsaturated species are described in U.S. Pat. No. 5,545,676 (Palazzotto et al.) include mono-, di-, and poly-(meth)acrylates (e.g., methyl acrylate, methyl methacrylate, ethyl acrylate, isopropyl methacrylate, n-hexyl acrylate, stearyl acrylate, allyl acrylate, glycerol diacrylate, glycerol triacrylate, ethylene glycol diacrylate, diethylene glycol diacrylate, triethylene glycol dimethacrylate,1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexaacrylate, bis[1-(2-acryloxy)]-p-ethoxyphenyldimethylmethane, bis[1-(3-acryloxy-2-hydroxy)]-p-propoxyphenyldimethylmethane trishydroxyethyl-isocyanurate trimethacrylate, the bis-acrylates and bis-methacrylates of polyethylene glycols of molecular weight about 200-500 grams/mole, copolymerizable mixtures of acrylated monomers such as those of U.S. Pat. No. 4,652,274 (Boettcher et al.), and acrylated oligomers such as those of U.S. Pat. No. 4, 642,126 (Zador et al.); unsaturated amides (for example, methylene bis-acrylamide, methylene bis-methacrylamide, 1,6-hexamethylene bis-acrylamide, diethylene triamine tris-acrylamide and beta-methacrylaminoethyl methacrylate); vinyl compounds (for example, styrene, diallyl phthalate, divinyl succinate, divinyl adipate, and divinyl phthalate); and the like; and mixtures thereof. Suitable reactive polymers include polymers with pendant (meth)acrylate groups, for example, having from 1 to about 50 (meth)acrylate groups per polymer chain. Examples of such polymers include aromatic acid (meth)acrylate half ester resin. Other useful reactive polymers curable by free-radical chemistry include those polymers that have a hydrocarbyl backbone and pendant peptide groups with free-radically polymerizable functionality attached thereto, such as those described in U.S. Pat. No. 5,235,015 (Ali et al.). Mixtures of two or more monomers, oligomers, and/or reactive polymers can be used if desired.

In some embodiments, the mask layer is applied and then cured to form the mask layer by heating, exposure to oxygen, and/or exposure to actinic radiation (e.g., ultraviolet and/or visible light). Particularly well-suited to this approach are curable mixtures of acrylic monomers having an average (meth)acrylic functionality of greater than 1, greater than 1.5, or even greater than 2. Exemplary mask layer precursor compositions include compositions comprising mono- and/or polyfunctional (meth)acrylic monomer(s) and free-radical initiators such as, for example, and organic peroxides, photoinitiators, and oxygen activated systems such as, for example, metal naphthenates and organoborane-amine complexes. Mask layer precursor compositions may be applied to the substrate as a 100% solids formulation, as a solution in solvent, or as a latex dispersion, for example.

Mask layers can be disposed on the surface (including the metallic surface) of the substrate by any suitable technique including solvent-casting, dip coating, and/or spray coating of a solution of mask layer precursor composition material in organic solvent and/or water followed by drying, for example. Preferably, the chosen method of application results a substantially uniform thickness of the resultant mask layer, although this is not a requirement.

Etchant

The etchant is a material that can etch away at least a portion of the mask layer. In some embodiments, the etchant comprises a mineral acid (or base). Exemplary acid etchants include: mineral acids such as, for example, hydrochloric acid, perchloric acid, sulfuric acid, nitric acid (an oxidizing acid), phosphoric acid, aqua regia; and organic acids such as, for example, oxalic acid, methanesulfonic acid, triflic acid, and acetic acid. Combinations of acids and different dilutions of acids (e.g., with water) may also be used. Exemplary base etchants include, alkali metal hydroxides, and alkali metal metasilicates. Other etchants may also be used.

In many embodiments, the etchant is simply brought into contact with the mask layer and eventually the metallic surface) to be etched for a specified time and at a specified nominal temperature, then rinsed away. The etchant may be applied by immersion, spraying, and/or any other suitable coating technique, for example.

In some embodiment, the etching process may include electrochemically-assisted etching, e.g., as described in U.S. Pat. Appl. Publ. 2004/0178081 (Gottschling et al.) or U.S. Pat. No. 8,313,637 (Uchida et al.).

After or during the etching procedure, the etchant can be removed; for example by rinsing with water and/or organic solvent. If etching was incomplete, the etching procedure can be restarted and continued to a desired degree of completion. In some cases, simultaneous or sequential mechanical abrasion may be used in addition to the etching process, however this is typically not necessary for successful practice of the present disclosure. Once etching is complete, the substrate is typically rinsed to remove debris and any etchant that may be present; however, this is not a requirement.

In addition to the mask layer composition, the etchant, and the metallic surface, the etching process is generally temperature dependent, with faster etching at higher temperatures. Moreover, the effect of temperature may not be linear, especially if phase transitions occur in the mask layer upon heating (e.g., above a glass transition point or a melting point). Accordingly, it is highly desirable that for widespread use in industry that the etchant and mask layer for each metallic selected a nominal temperature for practicing the present disclosure would be predetermined.

Accordingly, a kit for etching a specified metallic surface includes separate containers for a mask layer precursor composition and etchant, typically accompanied by a specified nominal temperature for the etching process to be carried out.

### Select Embodiments of the Present Disclosure

In a first embodiment, the present disclosure provides a method of finishing a metallic surface, the method comprising steps:
(a) disposing a mask layer onto an initial metallic surface of a substrate, wherein the mask layer has a major surface opposite the initial metallic surface that is smoother than the initial metallic surface;
(b) etching at least a portion of the initial metallic surface with an etchant to provide an etched surface, wherein on a depth basis:
   (i) the etchant etches said at least a portion of the mask layer and said at least a portion of the initial metallic surface at substantially the same rate; and/or
   (ii) the etchant penetrates said at least a portion of the mask layer and etches said at least a portion of the initial metallic surface at substantially the same rate; and
(c) separating the etchant from the etched surface, wherein the etched metallic surface is smoother than the initial metallic surface.

In a second embodiment, the present disclosure provides a method according to the first embodiment, wherein the etchant etches said at least a portion of the mask layer and said at least a portion of the initial metallic surface at substantially the same rate.

In a third embodiment, the present disclosure provides a method according to the first or second embodiment, wherein the mask layer is completely removed during step (b).

In a fourth embodiment, the present disclosure provides a method according to the first embodiment, wherein the etchant penetrates said at least a portion of the mask layer and etches said at least a portion of the initial metallic surface at substantially the same rate.

In a fifth embodiment, the present disclosure provides a method according to any of the first to fourth embodiments, wherein the sintered metallic surface is a surface of a substrate made by a sintering at least one powdered metal.

In a sixth embodiment, the present disclosure provides a method according to the fifth embodiment, wherein said substrate is a sintered metallic substrate.

In a seventh embodiment, the present disclosure provides a method according to any of the first to sixth embodiments, wherein the mask layer comprises a wax.

In an eighth embodiment, the present disclosure provides a method according to the seventh embodiment, wherein the wax comprises an amide wax.

In a ninth embodiment, the present disclosure provides a method according to any of the first to eighth embodiments, wherein the mask layer comprises a crosslinked hydrolyzable polymer.

In a tenth embodiment, the present disclosure provides a method according to any of the first to ninth embodiments, wherein the etchant comprises a mineral acid.

In an eleventh embodiment, the present disclosure provides a method according to the tenth embodiment, wherein the mineral acid comprises hydrochloric acid or sulfuric acid.

In a twelfth embodiment, the present disclosure provides a method according to any of the first to eleventh embodiments, wherein the etchant comprises an aqueous base.

In a thirteenth embodiment, the present disclosure provides a method according to any of the first to twelfth embodiments, wherein the etched metallic surface has a complex three-dimensional shape.

In a fourteenth embodiment, the present disclosure provides a method according to any of the first to thirteenth embodiments, further comprising adjusting the temperature to provide a predetermined nominal temperature at which the method is carried out.

In a fifteenth embodiment, the present disclosure provides a substrate having a metallic surface wherein at least a portion of the metallic surface is finished by a process comprising the method of any of the first to fourteenth embodiments.

In a sixteenth embodiment, the present disclosure provides a kit comprising components:

(a) a mask layer precursor composition for use in disposing a mask layer at least a portion of a metallic surface comprising at least one specified metal; and

(b) an etchant adapted for use with the mask layer and the at least one specified metal, wherein at a predetermined nominal temperature, and on a depth basis:
(i) the etchant etches said at least a portion of the mask layer and said at least a portion of the initial metallic surface at substantially the same rate; and/or
   (ii) the etchant is capable of permeating said at least a portion of the mask layer and etching said at least a portion of the metallic surface at substantially the same rate.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Example 1

A Premix A of 1 part of hardener 111061 and 4 parts of epoxy resin 111062, both from MetPrep Ltd., Coventry, United Kingdom, was prepared.

A solution of 0.55 parts of polyacrylonitrile powder (PAN) and 0.35 parts of leaf gelatin was made by dissolving in 10.00 parts of dimethyl sulfoxide (DMSO) heated to 90° C. After cooling to room temperature, 0.842 parts of Premix A was added with stirring, followed by 0.048 parts of 3M Fluorosurfactant FC 4430 from 3M Company. The mixture was cooled to 10° C. A pre-sanded titanium plate was sanded, and its finish was measured with a Mikrocad 3D-profilometer (LMI Technologies, Dublin, Ireland) before chilling in a freezer. The coated plate was then immersed in a chilled 30% solution of propan-2-ol in water to precipitate the PAN/gelatin mixture by removal of the DMSO by partition into the solvent mixture, leaving a polymer layer on the titanium part. This coating was then heated to 80° C. for 30 minutes to cure the epoxy resin.

For the etching process, the plate was connected to a power supply set to 1 Amp and 6 volts and mounted in an electrochemical cell for 15 minutes. Hydrochloric acid (35%) was used as the etchant. For resist removal, the part was rinsed in water, dried at 75° C., and then any residual resist was removed by ultrasonication in soapy water, drying, soaking in DMSO, and then washing again. Surface roughness of the Ti plate after sanding (i.e., the sanded surface roughness) but before etching, and after etching (i.e., the teched surface roughness) was measured before and after the etching step using a Mikrocad 3D-profilometer. Results are reported in Table 1, below.

TABLE 1

| | Sₐ, | S_{Z}, |
|---|---|---|
| Sample | microns | microns |
| Sanded Ti plate (pre-etch) | 15 | 634 |
| Ti plate Post-etch | 13.2 | 209 |

In Table 1, Sₐ is, as an absolute value, the average difference in height of each point on a surface compared to the arithmetical mean of a surface within a defined area; and S_{z} is defined as the sum of the 5 largest peak height values and the 5 largest pit depth values within a defined area.

### Example 2

A resist solution was prepared by combining: 56.79 parts of water, 6.81 parts of leaf gelatin, 7.07 parts of glycerol carbonate, 25.90 parts of urea-formaldehyde resin (80-1039A, Prefere, Aycliffe, UK), 0.37 parts of BYK 348 surfactant (BYK-Chemie GMBH, Wesel, Germany), and 3.06 parts of hexamethylene diamine diphosphate catalyst.

Aluminum slugs were sanded with P120 grit abrasive paper, then washed in water before cleaning in acetone. The surface profile measured with a Mikrocad 3D profilometer. One face of the slug was flood-coated with a thin layer of the above resist solution, which was dried and cured in an oven at 70° C. for 20 minutes. The remaining surfaces were covered with 3M LSE-300 acrylic transfer tape to prevent acid attack and the slug immersed in 5% HCl for 15 minutes. The resist was removed with hot soapy water and the etched surface finish was re-measured. Results are reported in Table 2, below.

TABLE 2

| Roughness | Test-piece- | Test-piece | Control - | Control - |
|---|---|---|---|---|
| parameter | unetched | etched | unetched | etched |
| Sₐ, | 2.4 | 1.3 | 1.8 | 1.6 |
| microns | | | | |
| S_{Z}, | 49.9 | 33.1 | 73.2 | 4.9 |
| microns | | | | |

### Example 3

Premix B was a solution of 20 parts of stearic acid in butyl acetate. Premix C was a solution of 20 parts of Deurex X52A sugar cane wax (Duerex AG, Elsteraue, Germany) dissolved in 100 parts of butyl acetate. Premix D was a solution of 5 parts of Premix B, 15 parts of Premix C, and 0.25 parts of Tytan

CP-219 (titanate coupling agent from Borica, Taipei, Taiwan).

An aluminum slug was sanded with diamond abrasive, cleaned, and coated with Premix D. After evaporating the solvent at room temperature for 40 minutes, and heating to 105° C. to melt the wax, the slug was cooled, masked on the un-coated areas with LSE-3000 tape and etched in 0.37 molar sodium hydroxide for the times shown in Table 3. The mask layer (i.e., wax) was removed with hot butyl acetate solvent and the surface finish change was measured with a Mikrocad 3D-profilometer. Results are reported in Table 3, below.

TABLE 3

| | Etch Time, | Sₐ, |
|---|---|---|
| Sample | minutes | microns |
| Sanded Al slug - control | — | 6.4 |
| Masked Al slug | 5 | 4.5 |
| Masked Al slug | 10 | 3.9 |

### Examples 4-6

Mask layer precursor solutions were prepared by combining methyl ethyl ketone, lauryl acrylate, Genomer 4215 hydrolyzable urethane acrylate (Rahn AG, Zurich, Switzerland), acryloyl morpholine oxide, Byk UV-3000 surfactant (BYK-Chemie GMBH), and benzoyl peroxide in amounts as reported in TABLE 4, below.

TABLE 4

| | EXAMPLE, parts | | |
|---|---|---|---|
| COMPONENT | 4 | 5 | 6 |
| methyl ethyl ketone | 1 | 1 | 1 |
| lauryl acrylate | 2 | 2 | 0 |
| Genomer 4215 | 3 | 1 | 3 |
| hydrolyzable urethane | | | |
| acrylate | | | |
| acryloyl morpholine oxide | 5 | 7 | 7 |
| Byk UV-3500 surfactant | 0.14 | 0.14 | 0.14 |
| benzoyl peroxide | 0.18 | 0.18 | 0.18 |

Aluminum brackets were sanded with 80+3M Cubitron 737U coated abrasive (3M Company) and the mask precursor solutions were flood-coated and left to drain, ensuring a thin coating.

Each example was cured at 90° C. for about 20 minutes. After cooling, they were etched in 15% NaOH solution for 8 mins. Any remaining resist material was rubbed off after ultrasonication in soapy water, and rinsing with water. A resist-free control was added for reference. The change in surface finish was measured using on a Mikrocad 3D profilometer. Results are reported in Table 5, below.

TABLE 5

| | Initial Sₐ, | Final Sₐ, | Initial S_{z}, | Final S_{z}, |
|---|---|---|---|---|
| EXAMPLE | microns | microns | microns | microns |
| 4 | 4.4 | 3.5 | 113 | 56 |
| 5 | 5.1 | 2.8 | 117 | 56 |
| 6 | 3.9 | 2.7 | 97 | 56 |
| Control | 3.9 | 4.5 | 130 | 118 |

### Examples 7-10

Aluminum slugs were abraded on a Struers sanding machine using green, nickel-bonded, diamond abrasive then cleaned and masked with LSE 300 transfer tape and polyester film on all faces where etching was not required, and the unmasked face cleaned with butyl acetate. Surface roughness of the abraded surface was measured on the Mikrocad profilometer.

To prime the surface, after pre-heating to 70° C. the slugs were immersed in 0.1 M oxalic acid (at the same temperature) for 1 minute to prime the surface. Bubbles of hydrogen were seen on the slug face during this process. if no bubbles were seen, it was a sign that the oxalic acid needed re-warming. The slug was warmed again to 70° C., before dipping into a 5% solution of Deurex stearamide wax A28 in butyl acetate, inverted, and the solvent allowed to evaporate flash-off, before repeating this process for a thicker resist coating. The part was then heated to 105° C. to allow the wax to melt into the surface features. The mask-coated aluminum slugs were etched with 1M H₂SO₃. Results are reported in Table 6, below.

TABLE 6

| | Condition | | |
|---|---|---|---|
| | Etch Time, | | Final Sₐ, |
| EXAMPLE | minutes | Temperature, ° C. | microns |
| 7 | 5 | 60 | 3.16 |
| 8 | 15 | 60 | 3.39 |
| 9 | 8 | 70 | 2.97 |
| 10 | 15 | 70 | 2.15 |

The preceding description, given in order to enable one of ordinary skill in the art to practice the claimed disclosure, is not to be construed as limiting the scope of the disclosure, which is defined by the claims and all equivalents thereto.

1-16. (canceled)

17. A method of finishing a metallic surface, the method comprising steps:
(a) disposing a mask layer onto an initial metallic surface of a substrate, wherein the mask layer has a major surface opposite the initial metallic surface that is smoother than the initial metallic surface;
(b) etching at least a portion of the initial metallic surface with an etchant to provide an etched surface, wherein on a depth basis:
(i) the etchant etches said at least a portion of the mask layer and said at least a portion of the initial metallic surface at substantially the same rate; and/or
(ii) the etchant penetrates said at least a portion of the mask layer and etches said at least a portion of the initial metallic surface at substantially the same rate; and
(c) separating the etchant from the etched surface, wherein the etched metallic surface is smoother than the initial metallic surface.

18. The method of claim 17, wherein the etchant etches said at least a portion of the mask layer and said at least a portion of the initial metallic surface at substantially the same rate.

19. The method of claim 17, wherein the mask layer is completely removed during step (b).

20. The method of claim 17, wherein the etchant penetrates said at least a portion of the mask layer and etches said at least a portion of the initial metallic surface at substantially the same rate.

21. The method of claim 17, wherein said substrate is a sintered metallic substrate.

22. The method of claim 17, wherein the mask layer comprises a wax.

23. The method of claim 22, wherein the wax comprises an amide wax.

24. The method of claim 17, wherein the mask layer comprises a crosslinked hydrolyzable polymer.

25. The method of claim 17, wherein the etchant comprises a mineral acid.

26. The method of claim 25, wherein the mineral acid comprises hydrochloric acid or sulfuric acid.

27. The method of claim 17, wherein the etchant comprises an aqueous base.

28. The method of claim 17, wherein the etched metallic surface has a complex three-dimensional shape.

29. The method of claim 17, further comprising adjusting the temperature to provide a predetermined nominal temperature at which the method is carried out.

30. A substrate having a metallic surface wherein at least a portion of the metallic surface is finished by a process comprising the method of claim 17.

31. A kit comprising components:
(a) a mask layer precursor composition for use in disposing a mask layer at least a portion of a metallic surface comprising at least one specified metal; and
(b) an etchant adapted for use with the mask layer and the at least one specified metal, wherein at a predetermined nominal temperature, and on a depth basis:
(i) the etchant etches said at least a portion of the mask layer and said at least a portion of the initial metallic surface at substantially the same rate; and/or
(ii) the etchant is capable of permeating said at least a portion of the mask layer and etching said at least a portion of the metallic surface at substantially the same rate.
